(19) United States
(12) Patent Application Publication
(10) Pub. No.: US 2009/0036080 A1
(43) Pub. Date: Feb. 5, 2009

(54) Multiple PLL high frequency receiver

(76) Inventors: Georgios Palaskas, Portland, OR (US); Rajarshi Mukhopadhyay, Richardson, TX (US); Stefano Pellerano, Beaverton, OR (US)

Correspondence Address: LeMOINE PATENT SERVICES, PLLC, C/O INTELLEVATE, P. O. BOX 52050, MINNEAPOLIS, MN, 55402, US

(21) Appl. No.: 11/888,307

(22) Filed: Jul. 31, 2007

(51) Int. Cl. H04B 7/00

(52) U.S. Cl. 455/260

(57) ABSTRACT

A radio receiver includes a first PLL to provide a first local oscillator signal to convert an RF signal to an IF signal, and a second PLL to provide a second local oscillator signal to convert the IF signal to baseband. The first PLL operates at a higher frequency with optimized performance, but it has limited tuning ability. The second PLL operates at a lower frequency and has more tuning ability to compensate for the first PLL lack of it. The first PLL provides an inter-PLL control signal to the second PLL to influence the frequency at which the second PLL operates.

### FIELD

The present invention relates generally to radio receivers, and more specifically to radio receivers that include multiple phase lock loop circuits.

### BACKGROUND

Abundant unlicensed spectrum around 60 GHz promises to support very high data rate communications. For example, wireless personal area networks (WPANs), home entertainment, or backhaul applications stand to benefit from this spectrum. Voltage controlled oscillators (VCOs) and phase lock loops (PLLs) operating at such high frequencies are very difficult to design and might limit the performance of the overall communications link.

### BRIEF DESCRIPTION OF THE DRAWINGS

FIG. 1 shows a diagram of a radio receiver having multiple phase lock loop circuits;

FIGS. 2 and 3 show diagrams of phase lock loop circuits; and

FIG. 4 shows a flowchart in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

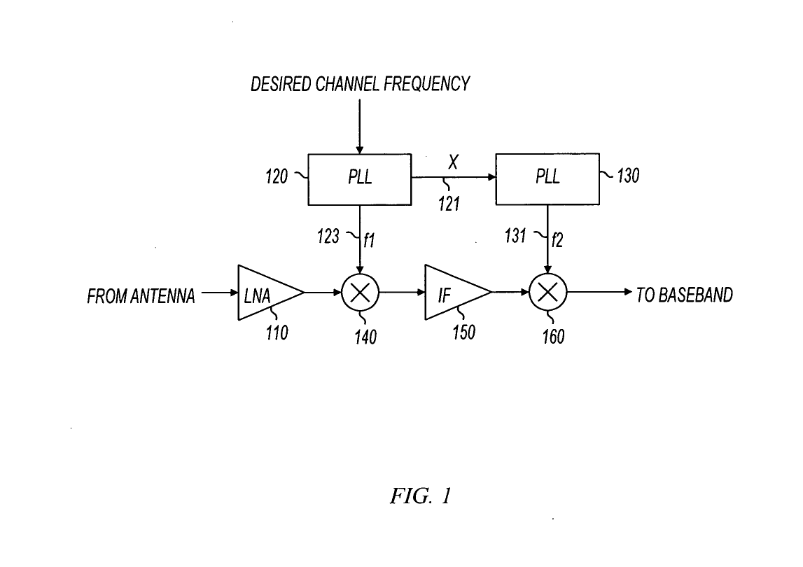

FIG. 1 shows a diagram of a radio receiver having multiple phase lock loops. Radio receiver 100 includes first PLL 120, second PLL 130, low noise amplifier (LNA) 110, mixer 140, intermediate frequency (IF) amplifier 150, and mixer 160.

In operation, a radio frequency (RF) signal is received by an antenna (not shown) and provided to LNA 110 for amplification. This amplified RF signal is present at one port of mixer 140. Mixer 140 downconverts the RF signal to an intermediate frequency (IF) using a first local oscillator signal provided by first PLL 120 at frequency (f1). IF amplifier 150 amplifies the IF signal, and mixer 160 then down converts the IF signal to baseband using a second local oscillator signal provided by second PLL 130 at frequency (f2).

In various embodiments of the present invention, first PLL 120 is a high frequency PLL that provides a local oscillator signal (f1) on node 123 to downconvert the RF signal to a relatively small IF frequency (e.g. around 5 GHz). Second PLL 130 provides a local oscillator signal (f2) on node 131 to perform the final downconversion from IF to baseband. First PLL 120 is optimized for performance and power dissipation, possibly at the expense of tunability and resolution. The required tunability and resolution are restored by second PLL 130. This is possible since what matters for the system of FIG. 1 is f1+f2, rather than the values of the two frequencies individually.

High tunability and resolution are much easier to achieve for second PLL 130 since it operates at a much lower frequency. The frequency f1 of first PLL 120 is not known apriori, but rather changes in order to optimize the performance of first PLL 120. An inter-PLL control signal X on node 121 informs second PLL 130 what frequency first PLL 120 is operating at, so that second PLL 130 can adjust its frequency accordingly and obtain the desired f1+f2 value. The control line labeled “Desired Channel Frequency” defines the frequency of the channel to which radio receiver 100 is to be tuned. The desired channel frequency is f1+f2+fx, where fx is a constant that depends on the receiver architecture used, e.g. low-IF, direct conversion, etc.

In general, a VCO covering a wide frequency band typically has worse performance than a VCO covering a narrower frequency band. In FIG. 1, PLL 120 can be optimized for a small frequency range (limited tunability) in order to keep its performance reasonably good. PLL 130 will have to cover a wider frequency range to compensate for the limited tunability of PLL 120 but this might be much easier to achieve because of the lower operating frequency.

In general, a wide loop-bandwidth might be useful in a high frequency (e.g., 60 GHz) PLL in order to minimize the VCO noise contribution. This necessitates the use of a high reference frequency. If an integer divider is used, the frequency resolution of the high frequency PLL will suffer. A fractional divider can alleviate this problem, but might introduce fractional spurs (this problem will be particularly pronounced because of the very high operating frequency of the system). In FIG. 1, first PLL 120 is made to roughly tune to the correct frequency (e.g. using an integer divider) thus avoiding all these problems, and then second PLL 130 can be used to obtain the required frequency resolution.

Accordingly, the various embodiments of the present invention divide the VCO/PLL burden between two PLLs: the high frequency first PLL 120 has good performance (relative to its frequency) but limited tunability/resolution; and the low frequency second PLL 130 restores the tunability and resolution, but at a much lower frequency where these tasks are easier.

Although receiver 100 is described in the context of a 60 GHz communications system, this is not a limitation of the present invention. Dividing the VCO/PLL burden between two PLLs may be utilized in radios operating at any frequency with beneficial results.

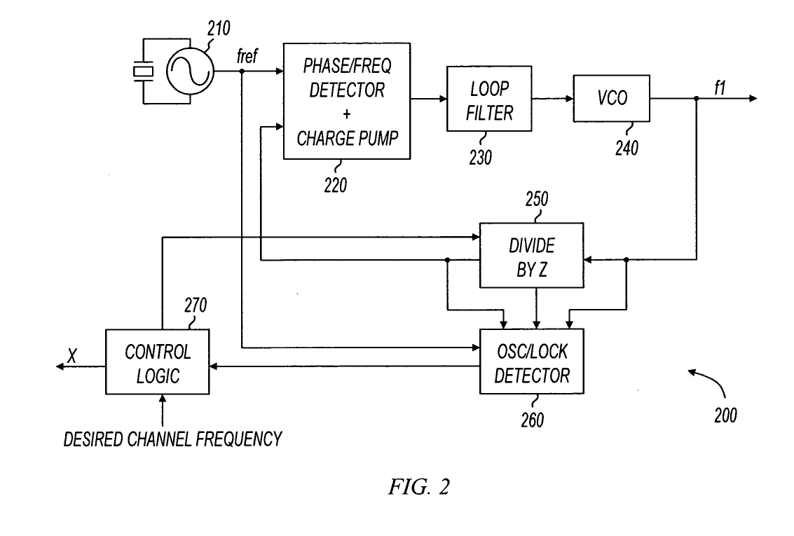

FIG. 2 shows a diagram of a phase lock loop circuit. PLL 200 may be used to implement the high frequency first PLL 120 (FIG. 1). PLL 200 includes oscillator 210, phase/frequency detector and charge pump 220, loop filter 230, VCO 240, and divide by Z circuit 250, all of which may be found in conventional PLLs. In operation, the output of VCO 240 is divided down by a factor Z and compared with a fixed reference frequency fref by phase/frequency detector and charge pump 220. The phase error is filtered by loop filter 230 and applied to VCO 240 to correct its frequency. In a conventional PLL, the division ratio Z is externally set, and may be a fixed design choice, according to the required VCO frequency. For example, in conventional PLLs, f1=Z*fref, where Z is a constant.

PLL 200 also includes control logic 270 and Osc/Lock detector 260. In various embodiments of the present invention, instead of tuning the VCO 240 to the desired frequency, the division ratio Z is adjusted until the VCO 240 achieves the desired frequency performance. This can be detected by monitoring the output of the VCO 240 and/or the divider 250 and/or other intermediate points using the Osc/Lock Detector 260. In some embodiments, the “Osc/Lock Detector” circuit ensures that the VCO 240 is oscillating locked to the reference signal fref. Circuits that implement these functions are known to those skilled in the art. More elaborate “Osc/Lock Detector” circuits that estimate performance metrics of the VCO (e.g. phase noise), rather than just guarantee functionality, are also within the scope of the present invention.

As described above, in a conventional PLL, the division ratio Z and the reference frequency fref are fixed, and the VCO frequency f1 changes until f1=Z fref is satisfied. In the embodiments represented by FIG. 2, since the oscillation frequency and/or locking range of the VCO can be very small and are not known apriori, the division ratio Z is varied until the “Osc/Lock Detector detects a lock. At this point f1 tracks fref by operation of the PLL action. Depending on the final value of Z that optimizes the VCO/divider performance, the frequency of second PLL 130 (FIG. 1) has to be adjusted accordingly. The control logic 270 also receives the desired channel frequency information that describes the input frequency that the system is trying to lock to (f1+f2 in FIG. 1). This information can be used to coarsely tune first PLL 120 close to the required channel frequency, while still allowing optimization. Control logic sends the inter-PLL control signal X to the second PLL to inform the correct frequency for the second PLL to tune to. The signal X is then used to set the second PLL 130 to the desired frequency.

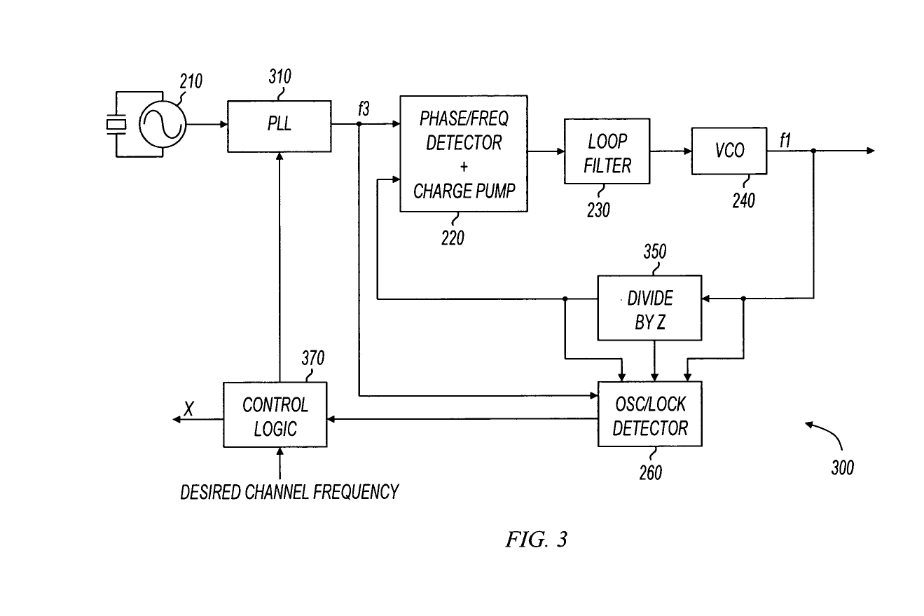

FIG. 3 shows a diagram of a phase lock loop circuit. PLL 300 may be used to implement the high frequency first PLL 120 (FIG. 1). PLL 300 includes oscillator 210, conventional PLL 310, phase/frequency detector and charge pump 220, loop filter 230, VCO 240, divide by Z circuit 350, Osc/Lock detector 260, and control logic 370. In embodiments represented by FIG. 3, the division ratio Z is fixed by circuit 350, but the control logic 270 causes PLL 310 to change the reference frequency f3 until the high frequency VCO 240 achieves the optimal performance (i.e. the VCO is locked to the reference signal). The reference frequency is generated by a conventional PLL 310 that receives its own fixed reference frequency from oscillator 210. The control logic 370 varies f3 by changing the division ratio of PLL 310 as is normally done in a conventional PLL. PLL 310 is a lower frequency PLL and can achieve the desired resolution, phase noise, and tunability much more easily than a higher frequency PLL.

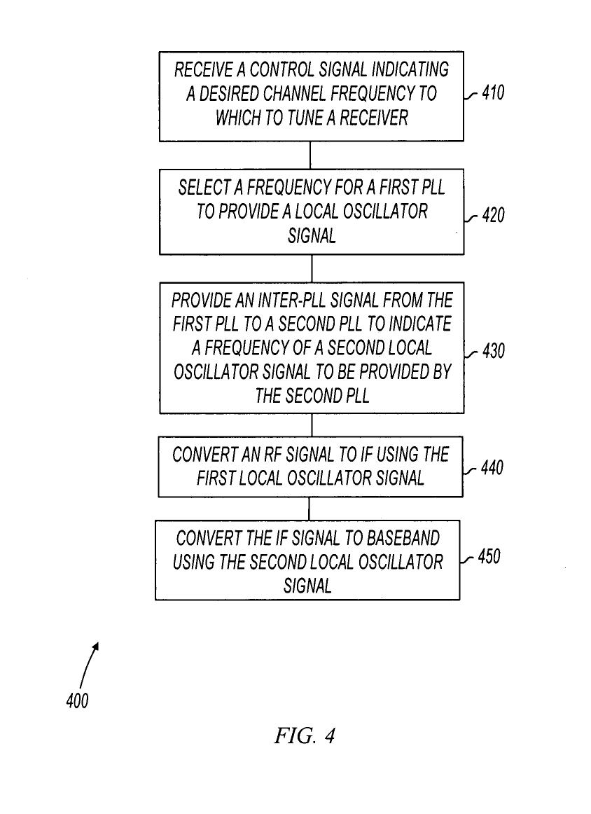

FIG. 4 shows a flowchart in accordance with various embodiments of the present invention. In some embodiments, method 400, or portions thereof, is performed by a radio receiver or a phase lock loop. In other embodiments, method 400 is performed by an integrated circuit or an electronic system. Method 400 is not limited by the particular type of apparatus performing the method. The various actions in method 400 may be performed in the order presented, or may be performed in a different order. Further, in some embodiments, some actions listed in FIG. 4 are omitted from method 400.

Method 400 is shown beginning with block 410 in which a control signal is received indicating a desired channel frequency to which to tune a receiver. In some embodiments, this corresponds to a receiver such as receiver 100 (FIG. 1) receiving the desired channel frequency. In other embodiments, this corresponds to a high frequency PLL such as PLL 120 (FIG. 1), PLL 200 (FIG. 2), or PLL 300 (FIG. 3) receiving the desired channel frequency.

At 420, a frequency f1 is selected for a first PLL. The first PLL is tuned to output this frequency as a first local oscillator signal. In general, f1 is not fixed, but rather is selected to provide desirable operation of the first PLL. For example, f1 may be chosen to limit spurious emissions or reduce power consumption. Any criteria may be used to select f1. When the first local oscillator is used to converter an RF signal to an intermediate frequency, the intermediate frequency is not always the same, but is instead a function of f1.

At 430, an inter-PLL signal is provided from the first PLL to a second PLL. The inter-PLL signal includes information that results in the second PLL tuning a second local oscillator signal to a frequency f2. The value of the inter-PLL signal changes based on the desired channel frequency provided to the first PLL, and the frequency f1 sourced by the first PLL. For example, the desired channel frequency may result in a total frequency conversion of f1+f2, the sum being dependent on the channel. The first PLL chooses a value for f1, and then through the inter-PLL signal, the second PLL is commanded to tune to f2.

At 440, an RF signal is converted to an IF signal using the first local oscillator signal, and at 450, the IF signal is converted to baseband using the second local oscillator signal.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. An apparatus comprising:
a first phase lock loop circuit to provide a first local oscillator signal to convert an RF signal to an IF signal, the first phase lock loop circuit having a control circuit to determine the frequency of the first local oscillator signal, and to provide an inter-PLL signal; and
a second phase lock loop circuit to provide a second local oscillator signal to convert the IF signal to a baseband signal, the second phase lock loop circuit being coupled to the first phase lock loop circuit to set a frequency of the second local oscillator signal in response to the inter-PLL signal.

2. The apparatus of claim 1 wherein the first phase lock loop circuit comprises:
a phase/frequency detector;
a loop filter coupled to an output node of the phase/frequency detector;
a voltage controlled oscillator coupled to the loop filter; and
a programmable frequency divider circuit coupled between the voltage controlled oscillator and the phase/frequency detector.

3. The apparatus of claim 2 further comprising a lock detector circuit to detect when the first phase lock loop circuit is locked.

4. The apparatus of claim 3 wherein the control circuit is coupled to be responsive to the lock detector.

5. The apparatus of claim 4 wherein the programmable frequency divider circuit is coupled to be responsive to the control circuit.

6. The apparatus of claim 1 wherein the first phase lock loop circuit comprises
a phase/frequency detector;
a programmable reference signal generator coupled to provide a reference signal to the phase/frequency detector;
a loop filter coupled to an output node of the phase/frequency detector;
a voltage controlled oscillator coupled to the loop filter; and
a frequency divider circuit coupled between the voltage controlled oscillator and the phase/frequency detector.

7. The apparatus of claim 6 further comprising a lock detector to detect when the loop is locked.

8. The apparatus of claim 7 wherein the control circuit is coupled to be responsive to the lock detector.

9. The apparatus of claim 8 wherein the programmable reference signal generator is coupled to be responsive to the control circuit.

10. A method comprising:
receiving a control signal indicating a desired channel frequency to which to tune a receiver, wherein a total frequency conversion needed to tune to the desired channel frequency is f1+f2, where f1 and f2 are frequency values;
selecting a value for f1 for a first phase lock loop (PLL) circuit to produce a first local oscillator signal; and
providing an inter-PLL signal to a second PLL circuit to indicate that the second PLL should provide a second local oscillator signal at substantially f2.

11. The method of claim 10 wherein selecting a value for f1 comprises modifying a frequency division multiple in a feedback path of the first PLL.

12. The method of claim 10 wherein selecting a value for f1 comprises modifying the frequency of a reference frequency signal provided to the first PLL.

13. The method of claim 10 further comprising:
converting a radio frequency (RF) signal to an intermediate frequency (IF) signal with the first local oscillator signal; and
converting the IF signal to a baseband signal with the second local oscillator signal.
